(19) United States
(12) Patent Application Publication
(10) Pub. No.: US 2006/0259775 A2
(43) Pub. Date: Nov. 16, 2006

(54) POLICY-PROTECTION PROXY

(75) Inventor: Brett M. Oliphant, Lafayette, IN (US)

Correspondence Address: BINGHAM MCHALE LLP, 2700 MARKET TOWER, 10 WEST MARKET STREET, INDIANAPOLIS, IN, 46204-4900, US

(73) Assignee: SecurityProfiling, Inc., Lafayette, IN (US)

(21) Appl. No.: 10/882,853

(22) Filed: Jul. 1, 2004

(51) Int. Cl. H04K 1/00

(52) U.S. Cl. 713/182

(57) ABSTRACT

Abstract of the Disclosure

A database maintains security status information on each device in a network, based on whether the device’s operating system, software, and patches are installed and configured to meet a baseline level of security. A network gateway proxy blocks connection attempts from devices for which the database indicates a substandard security status, but allows connections from other devices to pass normally. The database is preferably updated on a substantially real-time basis by client-side software run by each device in the network.

### Detailed Description of the Invention

### Cross-Reference to Related Applications

This application claims the benefit of U.S. Provisional Application No. 60/484,085. This application is also related to applications titled REAL-TIME VULNERABILITY MONITORING (Attorney Docket No. 36029-3), MULTIPLE-PATH REMEDIATION (Attorney Docket No. 36029-4), VULNERABILITY AND REMEDIATION DATABASE (Attorney Docket No. 36029-6), AUTOMATED STAGED PATCH AND POLICY MANAGEMENT (Attorney Docket No. 36029-7), and CLIENT CAPTURE OF VULNERABILITY DATA (Attorney Docket 36029-8), all filed on even date herewith. All of these applications are hereby incorporated herein by reference as if fully set forth.

### Field of the Invention

The present invention relates to computer systems, and more particularly to management of security of computing and network devices that are connected to other such devices.

### Background

With the growing popularity of the Internet and the increasing reliance by individuals and businesses on networked computers, network security management has become a critical function for many people. Furthermore, with computing systems themselves becoming more complex, security vulnerabilities in a product are often discovered long after the product is released into general distribution. Improved methods are needed, therefore, for managing updates and patches to software systems, and for managing configurations of those systems.

The security management problem is still more complex, though. Often techniques intended to remediate vulnerabilities (such as configuration changes, changes to policy settings, or application of patches) add additional problems. Sometimes patches to an operating system or application interfere with operation of other applications, and can inadvertently disable mission-critical services and applications of an enterprise. At other times, remediation steps open other vulnerabilities in software. There is, therefore, a need for improved security management techniques.

### Summary

One form of the present invention is a database of information about a plurality of devices, updated in real-time and used by an application to make a security-related decision. The database stores data indicating the installed operating system(s), installed software, patches that have been applied, system policies that are in place, and configuration information for each device. The database answers queries by one or more devices or applications attached by a network to facilitate security-related decision making. In one form of this embodiment, a firewall or router handles a connection request or maintenance of a connection based on the configuration information stored in the database that relates to one or both of the devices involved in the transmission.

Another form of the present invention includes a connection proxy that filters connections originating within the network. In particular, a preferred embodiment employs a proxy that denies connection attempts originating with devices in the network when the originating device has a status, reflected in the database, that fails to meet predetermined security characteristics in terms of installed operating system and software, patch levels, and system policy and configuration registry information.

Other specific embodiments of the invention will be apparent to those of ordinary skill in the art in light of the disclosure herein.

### Brief Description of the Drawings

Fig. 1 is a block diagram of a networked system of computers in one embodiment of the present invention.

Fig. 2 is a block diagram showing components of several computing devices in the system of Fig. 1.

Figs. 3 and 4 trace signals that travel through the system of Figs. 1 and 2 and the present invention is applied to them.

Fig. 5 is a flow chart of a filtering proxy method according to one embodiment of the present invention.

### Description

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

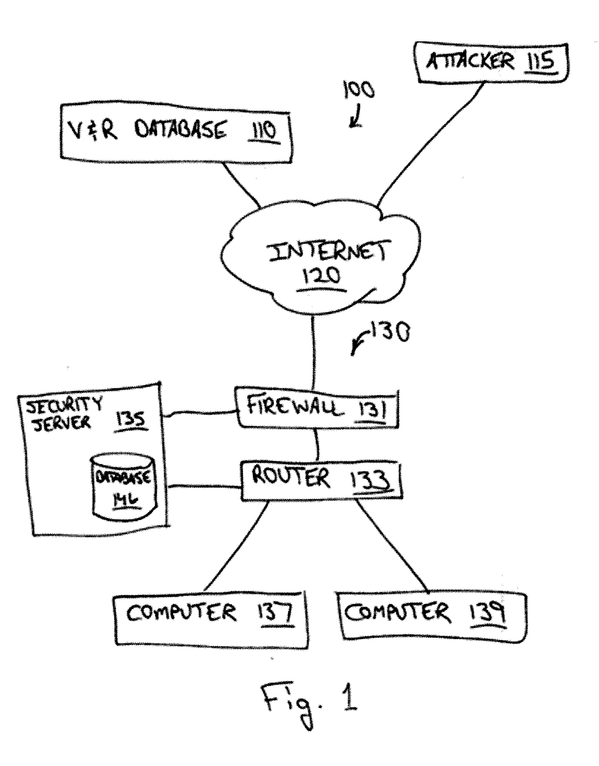

Generally, the present invention in its preferred embodiment operates in the context of a network as shown in Fig. 1. System 100 includes a vulnerability and remediation database 110 connected by Internet 120 to subnet 130. In this exemplary embodiment, firewall 131 serves as the gateway between Internet 120 and the rest of subnet 130. Router 133 directs connections between computers 137 and each other and other devices on Internet 120. Server 135 collects certain information and provides certain data services that will be discussed in further detail herein.

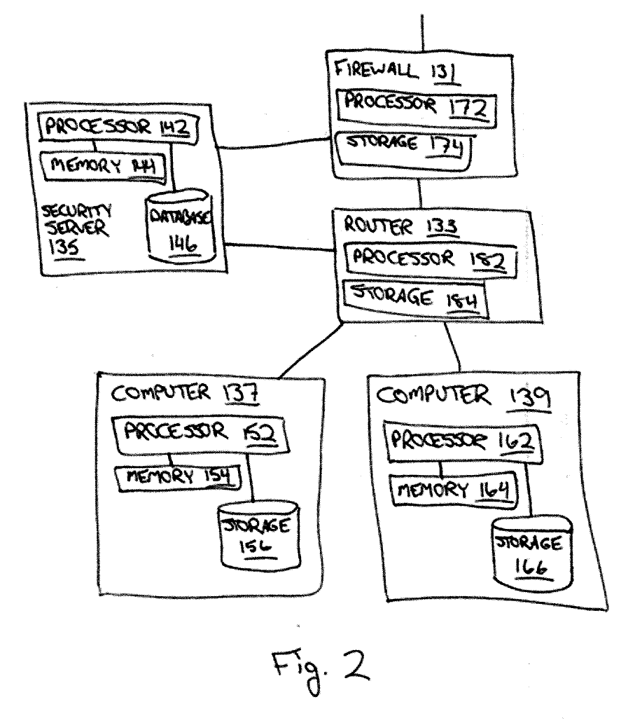

In particular, security server 135 includes processor 142, and memory 144 encoded with programming instructions executable by processor 142 to perform several important security-related functions. For example, security server 135 collects data from devices 131, 133, 137, and 139, including the software installed on those devices, their configuration and policy settings, and patches that have been installed. Security server 135 also obtains from vulnerability and remediation database 110 a regularly updated list of security vulnerabilities in software for a wide variety of operating systems, and even in the operating systems themselves. Security server 135 also downloads a regularly updated list of remediation techniques that can be applied to protect a device from damage due to those vulnerabilities. In a preferred embodiment, each vulnerability in remediation database 110 is identified by a vulnerability identifier, and the vulnerability identifier can be used to retrieve remediation information from database 110 (and from database 146, discussed below in relation to Fig. 2).

In this preferred embodiment, computers 137 and 139 each comprise a processor 152, 162, memory 154, 164, and storage 156, 166. Computer 137 executes a client-side program (stored in storage 156, loaded into memory 154, and executed by processor 152) that maintains an up-to-date collection of information regarding the operating system, service pack (if applicable), software, and patches installed on computer 137, and the policies and configuration data (including configuration files, and elements that may be contained in files, such as *.ini and *.conf files and registry information, for example), and communicates that information on a substantially real-time basis to security server 135. In an alternative embodiment, the collection of information is not retained on computer 137, but is only communicated once to security server 135, then is updated in real time as changes to that collection occur.

Computer 139 stores, loads, and executes a similar software program that communicates configuration information pertaining to computer 139 to security server 135, also substantially in real time. Changes to the configuration registry in computer 139 are monitored, and selected changes are communicated to security server 135 so that relevant information is always available. Security server 135 may connect directly to and request software installation status and configuration information from firewall 131 and router 133, for embodiments wherein firewall 131 and router 133 do not have a software program executing on them to communicate this information directly.

This collection of information is made available at security server 135, and combined with the vulnerability and remediation data from source 110. The advanced functionality of system 100 is thereby enabled as discussed further herein.

Turning to Fig. 2, one sees additional details and components of the devices in subnet 130. Computers 137 and 139 are traditional client or server machines, each having a processor 152, 162, memory 154, 164, and storage 156, 166. Firewall 131 and router 133 also have processors 172, 182 and storage 174, 184, respectively, as is known in the art. In this embodiment, devices 137 and 139 each execute a client-side program that continuously monitors the software installation and configuration status for that device. Changes to that status are communicated in substantially real time to security server 135, which continuously maintains the information in database 146. Security server 135 connects directly to firewall 131 and router 133 to obtain software installation and configuration status for those devices in the absence of a client-side program running thereon.

Processors 142, 152, 162 may each be comprised of one or more components configured as a single unit. Alternatively, when of a multi-component form, processor 142, 152, 162 may each have one or more components located remotely relative to the others. One or more components of processor 142, 152, 162 may be of the electronic variety defining digital circuitry, analog circuitry, or both. In one embodiment, processor 142, 152, 162 are of a conventional, integrated circuit microprocessor arrangement, such as one or more PENTIUM 4 or XEON processors from INTEL Corporation of 2200 Mission College Boulevard, Santa Clara, California, 95052, USA, or ATHLON XP processors from Advanced Micro Devices, One AMD Place, Sunnyvale, California, 94088, USA.

Memories 144, 154, 164 may include one or more types of solid-state electronic memory, magnetic memory, or optical memory, just to name a few. By way of non-limiting example, memory 40b may include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a DVD or CD ROM); a magnetically encoded hard drive, floppy disk, tape, or cartridge media; or a combination of any of these memory types. Also, memories 144, 154, 164 may be volatile, nonvolatile, or a hybrid combination of volatile and nonvolatile varieties.

In this exemplary embodiment, storage 146, 156, 166 comprises one or more of the memory types just given for memories 144, 154, 164, preferably selected from the non-volatile types.

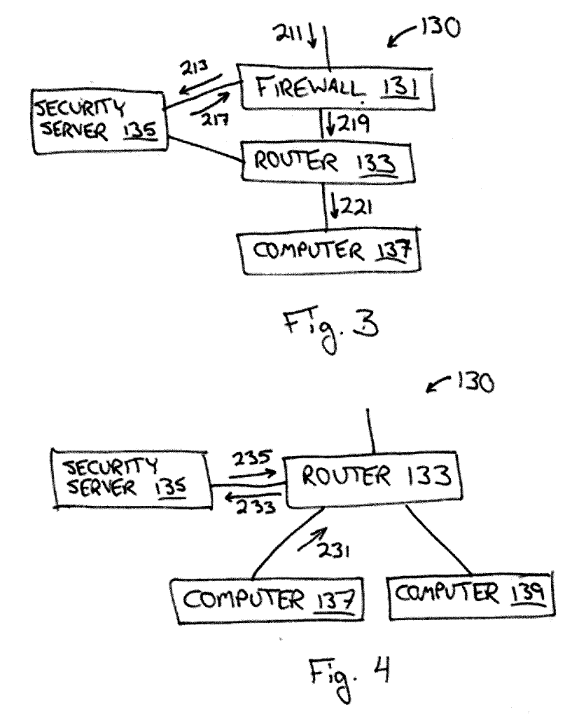

This collection of information is used by system 100 in a wide variety of ways. With reference to Fig. 3, assume for example that a connection request 211 arrives at firewall 131 requesting that data be transferred to computer 137. The payload of request 211 is, in this example, a probe request for a worm that takes advantage of a particular security vulnerability in a certain computer operating system. Based on characteristics of the connection request 211, firewall 131 sends a query 213 to security server 135. Query 213 includes information that security server 135 uses to determine (1) the intended destination of connection request 211, and (2) some characterization of the payload of connection request 211, such as a vulnerability identifier. Security server 135 uses this information to determine whether connection request 211 is attempting to take advantage of a particular known vulnerability of destination machine 137, and uses information from database 146 (see Fig. 2) to determine whether the destination computer 137 has the vulnerable software installed, and whether the vulnerability has been patched on computer 137, or whether computer 137 has been configured so as to be invulnerable to a particular attack.

Security server 135 sends result signal 217 back to firewall 131 with an indication of whether the connection request should be granted or rejected. If it is to be granted, firewall 131 passes the request to router 133 as request 219, and router 133 relays the request as request 221 to computer 137, as is understood in the art. If, on the other hand, signal 217 indicates that connection request 211 is to be rejected, firewall 133 drops or rejects the connection request 211 as is understood in the art.

Analogous operation can protect computers within subnet 130 from compromised devices within subnet 130 as well. For example, Fig. 4 illustrates subnet 130 with computer 137 compromised. Under the control of a virus or worm, for example, computer 137 sends connection attempt 231 to router 133 in an attempt to probe or take advantage of a potential vulnerability in computer 139. On receiving connection request 231, router 133 sends relevant information about request 231 in a query 233 to security server 135. Similarly to the operation discussed above in relation to Fig. 3, security server 135 determines whether connection request 231 poses any threat, and in particular any threat to software on computer 139. If so, security server 135 determines whether the vulnerability has been patched, and if not, it determines whether computer 139 has been otherwise configured to avoid damage due to that vulnerability. Security server 135 replies with signal 235 to query 233 with that answer. Router 133 uses response 235 to determine whether to allow the connection attempt.

In some embodiments, upon a determination by security server 135 that a connection attempt or other attack has occurred against a computer that is vulnerable (based on its current software, patch, policy, and configuration status), security server 135 selects one or more remediation techniques from database 146 that remediate the particular vulnerability. Based on a prioritization previously selected by an administrator or the system designer, the remediation technique(s) are applied (1) to the machine that was attacked, (2) to all devices subject to the same vulnerability (based on their real-time software, patch, policy, and configuration status), or (3) to all devices to which the selected remediation can be applied.

In various embodiments, remediation techniques include the closing of open ports on the device; installation of a patch that is known to correct the vulnerability; changing the device’s configuration; stopping, disabling, or removing services; setting or modifying policies; and the like. Furthermore, in various embodiments, events and actions are logged (preferably in a non-volatile medium) for later analysis and review by system administrators. In these embodiments, the log also stores information describing whether the target device was vulnerable to the attack.

A real-time status database according to the present invention has many other applications as well. In some embodiments, the database 146 is made available to an administrative console running on security server 135 or other administrative terminal. When a vulnerability is newly discovered in software that exists in subnet 130, administrators can immediately see whether any devices in subnet 130 are vulnerable to it, and if so, which ones. If a means of remediation of the vulnerability is known, the remediation can be selectively applied to only those devices subject to the vulnerability.

In some embodiments, the database 146 is integrated into another device, such as firewall 131 or router 133, or an individual device on the network. While some of these embodiments might avoid some failures due to network instability, they substantially increase the complexity of the device itself. For this reason, as well as the complexity of maintaining security database functions when integrated with other functions, the network-attached device embodiment described above in relation to Figs. 1-4 is preferred.

In a preferred embodiment, a software development kit (SDK) allows programmers to develop security applications that access the data collected in database 146. The applications developed with the SDK access information using a defined application programming interface (API) to retrieve vulnerability, remediation, and device status information available to the system. The applications then make security-related determinations and are enabled to take certain actions based on the available data.

In this preferred embodiment, router 133 serves as a connection proxy for devices and subnet 130, as will be understood by those skilled in the art. In addition to basic proxy functionality, however, router 133 accesses database 146 on security server 135 via the SDK at each connection attempt. If, for example, device 137 attempts to connect to any device where the connection must pass through the proxy server (router 133 in this example), such as a device on Internet 120, router 133 checks the security status of device 137 in database 146, using the real-time status therein to determine whether device 137 complies with one or more predetermined security policies. If it does, router 133 allows the connection to be made. If it does not, router 133 prevents the connection, preferably redirecting the connection to a diagnostic page that explains why the connection is not being made.

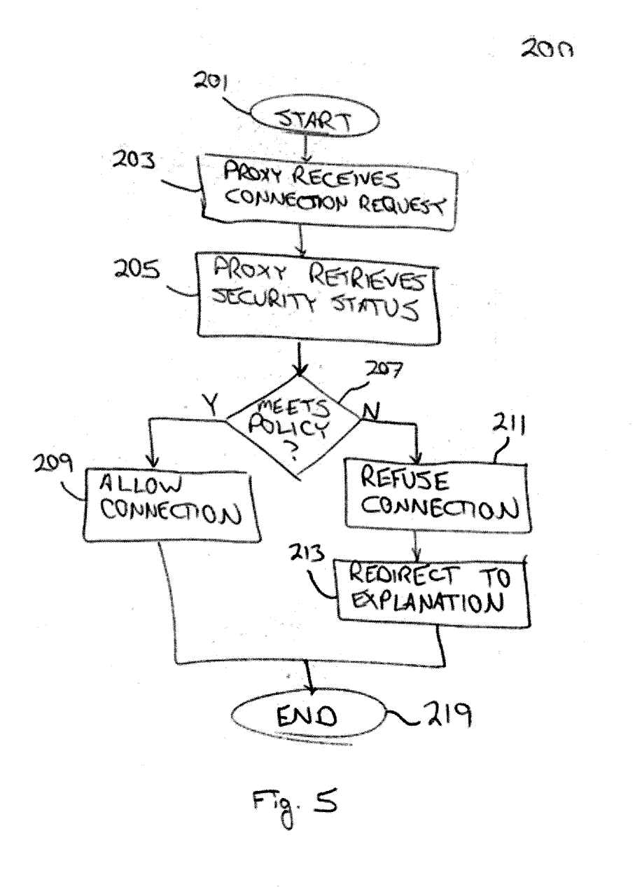

This system is illustrated by method 200 in Fig. 5. Method 200 begins with start point 201. The proxy (router 133 in the above example) receives a connection request at block 203, then retrieves the security status of the source device at block 205. This preferably uses the real-time updated status information from database 146 (see Fig. 2) at decision block 207. If the security status indicates that the source device complies with the predetermined security policy, the proxy allows the connection at block 209. If not, the proxy refuses the connection at block 211 and redirects the connection to an explanation message (such as a locally generated web page or other message source) at block 213. In either case, method 200 ends at end point 219.

In preferred embodiments, the determination and decision at block 207 apply a comprehensive minimum policy set that protects other devices in subnet 130 (see Fig. 1) from viruses, trojans, worms, and other malware that might be inadvertently and/or carelessly acquired due to the requested connection.

All publications, prior applications, and other documents cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiments have been shown and described and that all changes and modifications that would occur to one skilled in the relevant art are desired to be protected.

What is Claimed is:

1. A policy-enforcement proxy system comprising:
a first network of computing devices including a first device;
a proxy through which the first network is connected to a second network of computing devices; and
a database of configuration information comprising, for each of a plurality of devices in the first network:
an identifier for the device; and
a security status flag indicating whether the device complies with a predetermined security policy.;
wherein the proxy blocks connection requests from devices in the plurality of devices to devices in the second network when the security status flag associated with the requesting device indicates that the requesting device does not comply with the predetermined security policy.

2. The system of claim 1, wherein the identifier is a network address within the first network.

3. The system of claim 1, wherein the information in the database further comprises, for each of the plurality of devices, data identifying the operating system, software, and patches installed thereon.

4. The system of claim 1, wherein the information in the database further comprises, for each of the plurality of devices, data characterizing the system policy settings and configuration data for the device.

5. The system of claim 1, wherein the proxy redirects blocked connection requests to an explanatory message.

6. The system of claim 1, wherein in operation:
the proxy receives a connection request from the requesting device; and
the proxy responsively retrieves the configuration information for the requesting device from the database.

7. The system of claim 1, wherein the predetermined security policy includes a minimum policy set.

8. The system of claim 1, wherein the proxy and the database are incorporated into one device within a single physical enclosure.

9. A method, comprising:
providing a first network of computing devices including a first device;
providing a proxy through which the first network is connected to a second network of computing devices;
transferring data including configuration information from the first device to a server incorporating a database;
receiving a connection request signal at the proxy, wherein the connection request signal includes a request from the first device to connect with a second device in the second network; and
making a security-related determination regarding the connection request, wherein the making is performed by the proxy as a function of the transferred data.

10. The method of claim 9, wherein the making the security-related determination is a decision to block the connection request.

11. The method of claim 10, further comprising redirecting the blocked connection request to an explanatory message.

12. The method of claim 9, wherein the transferring is initiated by a software agent executed by a processor of the first device.

13. The method of claim 9, wherein:
the first network includes a third device; and
the connection request signal further includes a request from the first device to connect with the third device.

14. The method of claim 9, wherein:
the data transferred from the first device includes security status information that characterizes zero or more vulnerabilities to which the first device is subject;
the security status information is an indication of compliance of the first device with a predetermined security policy for the first network; and
the data is updated in substantially real time.

15. The method of claim 9, further comprising communicating update data from a vulnerability remediation database to the server.

16. The method of claim 15, wherein the update data includes one or more vulnerability remediation techniques.

17. The method of claim 16, further comprising:
selecting at least one of the vulnerability remediation techniques; and
remediating one or more vulnerabilities of the first device according to the selected techniques.

18. An apparatus, comprising a proxy device encoded with logic executable by one or more processors to communicate with a first database of configuration information and to selectively block connection requests from devices in a first network, wherein:
for each of a plurality of computing devices in the first network, the configuration information includes an identifier for the device and security status data for the device indicating whether the device complies with a predetermined security policy; and
the device blocks a connection request when the security status data associated with the requesting device does not indicate that the requesting device complies with the predetermined security policy.

19. The apparatus of claim 18, wherein the configuration information is transferred from each of the plurality of computing devices in the first network to the database in substantially real time.

20. The apparatus of claim 18, wherein the configuration information further includes, for each of the devices in the first network, data identifying the operating system, software, and patches installed thereon.

21. The apparatus of claim 18, wherein the configuration information further includes, for each of the devices in the first network, data characterizing the system policy settings and configuration data.

22. The apparatus of claim 18, wherein the proxy redirects blocked connection requests to an explanatory message.

23. The apparatus of claim 18, wherein the proxy retrieves the configuration information associated with the requesting device from the database upon receiving the connection requests.

24. A system, comprising:
a plurality of computing devices, each comprising at least one processor and memory, wherein the memory is encoded with programming instructions executable by the processor;
a server incorporating a database of configuration information and remediation techniques, wherein the server is operable to select a remediation technique from the database and remediate a vulnerability of one of the plurality of computing devices according to the selected remediation technique; and
a proxy that allows or denies connection requests from the plurality of computing devices as a function of the configuration information, wherein the information includes security status data for the requesting device operable to indicate whether the requesting device complies with a predetermined security policy.

25. A method, comprising:
providing a first network of computing devices including a first device;
providing a proxy through which the first network is connected to a second network of computing devices;
transferring data including configuration information from the computing devices in the first network to a server incorporating a database;
receiving a connection request at the proxy, wherein the connection request is a request from the first device to connect with a second device in the second network;
retrieving the data associated with the first device, wherein the data indicates whether the device complies with a predetermined security policy; and
making a security-related determination regarding the connection request, wherein the making is performed by the proxy as a function of the retrieved data.

26. The method of claim 25, wherein the configuration information comprises data identifying the operating system, software, and patches installed on the first device.

27. The method of claim 25, wherein the configuration information comprises data characterizing the system policy settings for the first device.
